(19) United States
(12) Patent Application Publication
(10) Pub. No.: US 2023/0188222 A1
(43) Pub. Date: Jun. 15, 2023

(54) MEASUREMENT DEVICE INDEPENDENT QUANTUM SECURE DIRECT COMMUNICATION WITH USER AUTHENTICATION

(71) Applicant: QULABZ INC., Kendall Park, NJ (US)

(72) Inventors: Nixon PATEL, Kendall Park, NJ (US); Goutam Kumar PAUL, Kolkata (IN); Nayana DAS, West Bengal (IN)

(21) Appl. No.: 18/074,373

(22) Filed: Dec. 2, 2022

(30) Foreign Application Priority Data
Dec. 2, 2021 (IN) 202131056008

(51) Int. Cl. H04B 10/70; G06N 10/20

(52) U.S. Cl. CPC H04B 10/70; G06N 10/20

(57) ABSTRACT

Approaches for implementing MDI-QSDC with user authentication are described. A sending system may prepare a first set of entangled qubit bit pairs, wherein the qubit bit pairs are prepared randomly. The first set of entangled qubit bit pairs may be separated into a first particle sequence and a second particle sequence. Thereafter, a second set of entangled qubit bit pairs based on an identifier corresponding to the quantum communication system may be prepared. A first set of decoy photons may be interleaved into the first particle sequence and a first single photon sequence, and a second set of decoy photons into the second particle sequence and the second single photon sequence to provide a first and a second sequence of single qubits. The second sequence is communicated to an untrusted third party for measurement based on which communication may be continued.

### BACKGROUND

Security of communication between two or multiple parties is a fundamental criterion for evaluating performance of any communication network. Traditional communication schemes are secured through encryption techniques, relying on pre-shared key and cryptographic protocols built on the computational difficulty of certain mathematical problems, for example, the RSA public key scheme. Such schemes have their own set of advantages as well as technical challenges. With the advent of quantum computing, the security of such traditional cryptographic communication has become a concern.

Quantum communication, in principle, provides unconditional security for exchanging information over public channels, since its security is based on the distinct characters based on quantum mechanics, such as quantum entanglement. In such implementations, ‘eavesdroppers’ may not gleam any useful information during a quantum communication process without introducing perturbations that inevitably reveal their interception, and also impact the integrity of the message itself.

Certain approaches, such as Quantum Key Distribution (QKD) addresses certain issues pertaining traditional modes of secure communication. Another protocol, referred to as Quantum Secure Direct Communication (QSDC) has been developed which involves communication of information directly without key distribution. This in turn reduces security loopholes associated with key storage and ciphertext attacks, offering a different mechanism for secure communication protocols. Yet another protocol, referred to as Measurement device independent Quantum Secure Direct Communication (MDI-QSDC) has also been developed which involves performing all the measurements by an untrusted third party (UTP) during the communication process using imperfect devices. This in turn reduces the risk of detector side channel attacks.

### BRIEF DESCRIPTION OF FIGURES

Systems and/or methods, in accordance with examples of the present subject matter are now described and with reference to the accompanying figures, in which:

FIG. 1 illustrates a communication environment for measurement device independent quantum secure direct communication with user authentication, as per an example;

FIG. 2 illustrates a quantum computing system for implementing measurement device independent quantum secure direct communication with user authentication, as per an example;

FIGS. 3A-3C illustrate method steps as a signal flow diagram depicting operation of a measurement device independent quantum secure direct communication with user authentication in a quantum computing device, as per one example.

### DETAILED DESCRIPTION

As mentioned above, a variety of quantum communication protocols are being developed. Quantum secure direct communication (QSDC) is emerging as an important branch of quantum communication, based on the principles of quantum mechanics for the direct transmission of information. QSDC enables transmission of messages directly without establishing some prior key for encryption and decryption. QSDC may be used to transmit the message deterministically through a quantum channel. Since QSDC protocols involve direct transmission of messages through the quantum channel, they typically may require higher security than QKD protocols. To this end, information leakage problem is a challenge in the direct communication protocols, should messages be transmitted using QSDC based protocols. Although, MDI-QSDC protocols may prevent data leakage or theft from side channel attacks they still fail to facilitate identity authentication with the communication system.

Thus, one of the aspects that will further security in a communication is identity authentication. Identity authentication is critical as it prevents an eavesdropper to impersonate a legitimate party or parties within a communication session.

Approaches for implementing measurement device independent quantum secure direct communication (MDI-QSDC) with user authentication are described. In the proposed invention, the MDI-QSDC based communication with user authentication utilizes an Einstein-Podolsky-Rosen pair (EPR) for implementing such mutual authentication. As may be understood, an EPR pair is a pair of qubits (quantum bits) that are in a Bell state. In one example, Bell basis may be represented as follows:

$$Bell basis = \{ \vert {Φ}^{+} 〉 , \vert {Φ}^{-} 〉 , \vert {Ψ}^{+} 〉 , \vert {Ψ}^{-} 〉 \} basis .$$

In addition to the above, the present description also relies on certain nomenclatures. The various nomenclatures and representations utilized are indicated below, in one example:

$$\vert + 〉 = \frac{1}{\sqrt{2}} ( \vert 0 〉 + \vert 1 〉 ) , \vert - 〉 = \frac{1}{\sqrt{2}} ( \vert 0 〉 - \vert 1 〉 ) . \\ X basis = \{ \vert + 〉 , \vert - 〉 \} basis . \\ I = \vert 0 〉 〈 0 \vert + \vert 1 〉 〈 1 \vert . \\ {σ}_{x} = \vert 1 〉 〈 0 \vert + \vert 0 〉 〈 1 \vert . \\ i {σ}_{y} = \vert 0 〉 〈 1 \vert - \vert 1 〉 〈 0 \vert . \\ {σ}_{z} = \vert 0 〉 〈 0 \vert - \vert 1 〉 〈 1 \vert . \\ H = \frac{1}{\sqrt{2}} ( {σ}_{x} + {σ}_{z} )$$

is the Hadamard operator.
S_{f}=i-th element of finite sequence S.
S_{A,i}=i-th element of finite sequence S_{A}.

It may be noted that the above-mentioned nomenclatures and representations are only for ease of reference and in no way are to be construed as a limitation. Other examples and representations may also be possible without deviating from the scope of the present subject matter.

Continuing with the present subject matter, the MDI-QSDC communication with user authentication involves a sender inserting check bits randomly inside a secret message M to generate a new string M′. It further involves a receiver preparing a first set of EPR pairs randomly with elements in |Φ⁺ [symbol] , |Φ⁻ [symbol] , |Ψ⁺ [symbol] and | [symbol] ⁻ [symbol] states (i.e., in entangled states). The prepared set of entangled qubits are further divided into two particle sequences (hereafter, referred as first particle sequence S_{A} and a second particle sequence S_{B}), wherein each of these sequences is formed by taking one qubit from each EPR pair. Further, the receiver prepares a second set of EPR pairs according to its identifier which is represented by identity (Id_{B}) and divides them into two sequences of photons (hereafter, referred as first single photon sequence I_{A} and second single photon sequence I_{B}). Furthermore, a first set and a second set of decoy photons (hereafter, referred to as D_{A} and D_{B}) are randomly produced by the receiver. Thereafter, receiver interleaves the qubits of the previously generated sequences to generate two new sequences (hereafter, referred to as first sequence of single qubit bits Q_{A} and second sequence of single qubit bits Q_{B}). Finally, the sequence Q_{A} is shared with the sender and the afterwards the receiver announces the positions of qubits I_{A} and D_{A}.

After receiving the qubits from the receiver, the sender separates the qubits of S_{A}, I_{A} and D_{A} from Q_{A}. Then, the sender randomly selects N qubits from S_{A} to encode a secret message M′, and uses the remaining K qubits (hereafter, referred to as C_{A}) to encode its secret identity Id_{A}. Thereafter, sender preforms cover operation using a unitary operator on S_{A}, I_{A}, D_{A} to transform them into sequences modified sequences S′_{A}, I′_{A}, D′_{A} respectively and further, it interleaves I′_{A} with S′_{A} randomly to form modified first sequence of single qubit bits Q′_{A}. Thereafter, it sends the modified first set of decoy photons D′_{A} to an Untrusted Third Party or UTP, comprising a measurement device for performing measurements. In an example, the measurement device is a type of an imperfect measurement device.

Continuing further, once the UTP receives the sequences D′_{A} and Q′_{A}, the sender announces the cover operation performed by in D′_{A} and the receiver announces the preparation basis for qubits of D_{A}. Thereafter, the UTP performs its measurements and announces its results to both the sender and receiver. As may be understood, from the measurement result (interchangeably referred to as measurements), the sender and receiver can calculate the error in the communication channel from receiver to sender and decide whether to continue or abort the communication process. As may be understood, if the error is significant the sender and receiver can determine that communication channel is compromised by an eavesdropper.

In case, there is no issue with the measurements, then they may proceed further with the communication process. Thereafter, the sender sends the Q′_{A} to the UTP and announces its preparation basis for qubits of Q′_{A}. Similarly, the UTP performs its measurements and announces its measurement. Again, from the announced measurements the sender calculates the error in the communication channel from sender to UTP and decide whether to continue or abort the communication process. As may be understood, if the error is significant the sender can determine that communication channel is compromised by an eavesdropper.

Finally, the receiver sends the sequence Q_{B} to the UTP and announces its preparatory basis for it. Similarly, the UTP performs its measurements and announces its measurement. Again, from the announced measurements the receiver calculates the error in the communication channel from receiver to UTP and decide whether to continue or abort the communication process. As may be understood, if the error is significant the receiver can determine that communication channel is compromised by an eavesdropper.

If the communication continues, i.e., the error as determined in the previous step is not significant, both the sender and receiver may perform a security check of the quantum communication channel and also assess the authenticity of the each other. To this end, the sender may announce the position operations of the qubits of I′_{A} and the receiver announces the positions of the qubits of I_{B}. Now for 1≤i≤k, UTP measures the i-th qubit pair (I′_{A,i}, I_{B,i}) in bell basis and announces the results. Here, it is pertinent to note that, it is assumed that both the sender and receiver know the secret identity i.e., Id_{A} and Id_{B} of each other. Now, since the sender already knows the Id_{B}, it compares the measurement result with (I′_{A,i}, I_{B,i}) to determine whether the identity of the receiver is legitimate or not based on which it may choose to continue or abort the communication process.

Thereafter, sender sends the positions of the qubits of C_{A} corresponding to its identity Id_{A} and the UTP measures those qubits with their partner qubits from S_{B} (referred as the set C_{B}) in Bell bases and announces the measurement result. Since, the receiver already knows Id_{A}, it compares the measurement results with Id_{A} and checks if the sender is a legitimate or not. Then, the UTP measures each qubit pair from (S′_{A}, S_{B}) in Bell basis and announces the measurement result. From the knowledge of (S_{A}, S_{B}) and (S′_{A}, S_{B}), the receiver decodes the classical bit string M′. Finally, the sender announces the check bits to the receiver in a public manner so that the receiver can compare the check bits with M′ to reproduce the original secret message M, thus completing the communication process.

As mentioned previously (and will be discussed further in the present explanation), the present MDI-QSDC communication protocol utilizes sequences prepared with one qubit from an EPR pairs as a basis to perform user authentication and send their secret messages with each other simultaneously. Since, the EPR pairs are chosen arbitrarily, detection and unauthorized retrieval of message by any eavesdropper is avoided and therefore the protocol remains secure. These approaches may be implemented in a variety of quantum hardware. In an example, the measurement in the UTP may be in performed by a variety of measurement devices. In another example, the receiver uses one EPR pair to exchange one-bit message from each other and thus saving computational resources.

Implementation of the above approaches exhibit greater security in communication of messages and has been found to be resilient against conventional attack strategies, and efficiently prevent eavesdropper from obtaining access to the encoded messages. Furthermore, the approaches when implemented on quantum devices are also found to be less susceptible to noise in quantum devices and are robust to error. Additionally, these approaches when implemented save network resources as the number of qubits required per message bit along with the number of measurement required per message is less than conventional QSDC and MDI protocols. These approaches and other examples are further described in the conjunction with the accompanying figures.

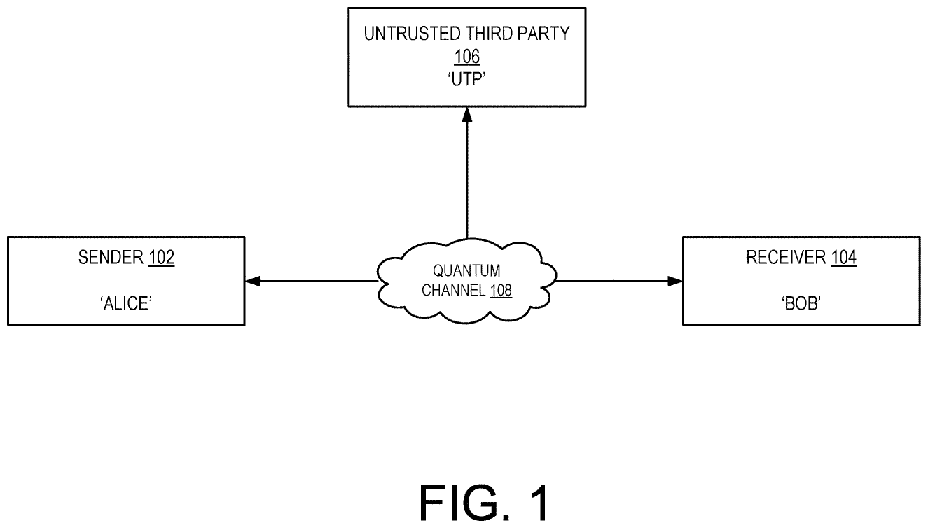

FIG. 1 is a block diagram illustrating a communication environment 100 for MDI-QSDC with user authentication, according to an example of the present subject matter. The communication environment 100 is explained in the context of a sender 102 (denoted with the archetype ‘Alice’ at certain instances), an untrusted third party 106 (denoted as ‘UTP’) and a receiver 104 (denoted with the archetype ‘Bob’ at certain instances). Both sender 102, UTP 106 and receiver 104 in turn may be communicating over a quantum communication channel 108. It may be noted that the reference to sender 102 and receiver 104 indicate references to systems which may be in the process of sending or transmitting and receiving messages, respectively, or otherwise engaging in Measuring Device Independent-Quantum Direct Secure Communication (MSI-QSDC), as per the approaches as explained herein. Further, it may be noted that the UTP 106 may comprise an imperfect measuring device for measuring various degrees of freedom of a qubit. The same are used for ease of reference and explanation and should not be used as limiting the scope of the claimed subject matter in any way.

The manner in which the communication between the sender 102 and the receiver 104 are described with the sender 102 having an n-bit secret message m, which she wants to send to the receiver 104, i.e., Bob through quantum communication channel 108. In the context of the present example, sender 102 and receiver 104 may maintain their previously shared k-bit authentication identities. In an example, the number k may be even. The respective identities may in turn be denoted by Id_{A} and Id_{B}, respectively. In an example, the identities may be based on a quantum key distribution (QKD) established earlier among other possibilities. For the purposes of explanation, we will denote that the message which sender 102 wishes to securely communicate to receiver 104, as M. The message M in turn may include sub-messages M=M₁M₂ . . . Mₙ.

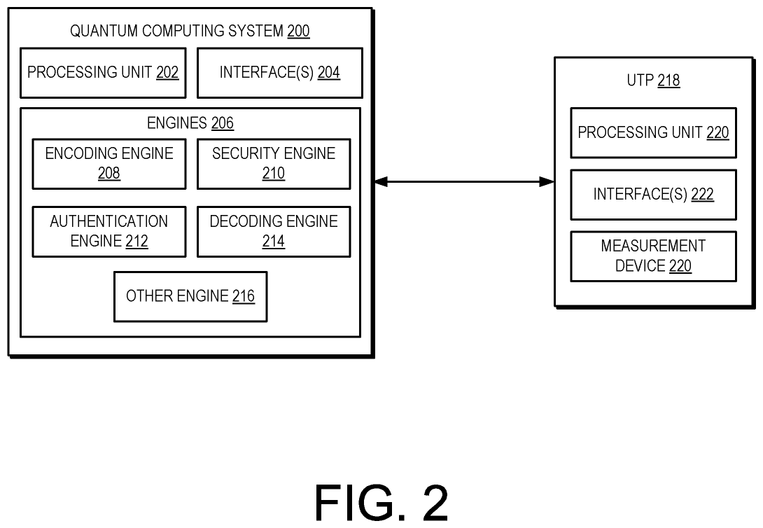

Each of the sender device 102 (i.e., Alice) or the receiver 104 (i.e., Bob) may be further implemented as the quantum computing system 200 as depicted in FIG. 2. FIG. 2 depicts a quantum computing system 200 (referred to as system 200) for implementing measurement device independent quantum secure direct communication with user authentication. To this end, the system 200 may include a processing unit 202, interfaces 204 and engines 206. The processing unit 202 may include qubit processors or similar circuitry which may be implementing a quantum qubit processor. The interfaces 204 may enable communication of the signals or data between different logical layers (not depicted for sake of brevity) constituting the quantum computing system 200. It may be noted that the system 200 may include further supporting infrastructure, hardware and accompanying equipment and classical processing machines, collectively functioning for implementing the quantum computing system 200. These are also not depicted for sake of brevity and or ease in explanation. The receiver device 104 (i.e., Bob) may be implemented by a similar quantum computing system (not shown here for the sake of brevity) comprising the same components as the quantum computing system 200 being depicted in FIG. 2. As may be understood, this is due to the fact that both the sender 102 and the receiver 104 implement similar methodologies. To that end, receiver device 104 (i.e., Bob) may also include a similar processing unit, interfaces, and engines that implement functionalities analogous to that of system 200.

Returning to the present process, the engines 206 may be implemented as a combination of hardware and programming, for example, programmable instructions to implement a variety of functionalities. In examples described herein, such combinations of hardware and programming may be implemented in several different ways. For example, the programming for the engines 206 may be executable instructions. In an example, the engines 206 may include a processing resource, for example, either a single processor or a combination of multiple processors, to execute one or more instructions. In the present examples, the non-transitory machine-readable storage medium may store instructions, that when executed by the processing resource, implement engines 206. In other examples, the engines 206 may be implemented as electronic circuitry.

The engines 206 may further include an encoding engine 208, a security engine 210, an authentication engine 212, a decoding engine 214 and other engines 216. It may be noted that the decoding engine 214 would be functional if the system 200 were to be receiving encoded messages from a sender. For example, the decoding engine 214 may be implemented within the sender 102 (i.e., Alice) for decoding encoded messages received from the receiver 104 (i.e., Bob), and vice versa.

Continuing further, the untrusted third party depicted as UTP 106 in FIG. 1 is now depicted as UTP 218 in FIG. 2. FIG. 2 depicts a UTP 218 for implementing the measurements within the MDI-QSDC. To this end, the UTP 218 may include a processing unit 220, interfaces 222 and a measuring device 224. The processing unit 220 may too include qubit processors or similar circuitry which may be implementing a quantum qubit processor. The interfaces 222 may enable communication of the signals or data between different logical layers (not depicted for sake of brevity) constituting the UTP 218. It may be noted that the UTP 218 may include further supporting infrastructure, hardware and accompanying equipment and classical processing machines, collectively functioning for implementing the UTP 218. These are also not depicted for sake of brevity and or ease in explanation.

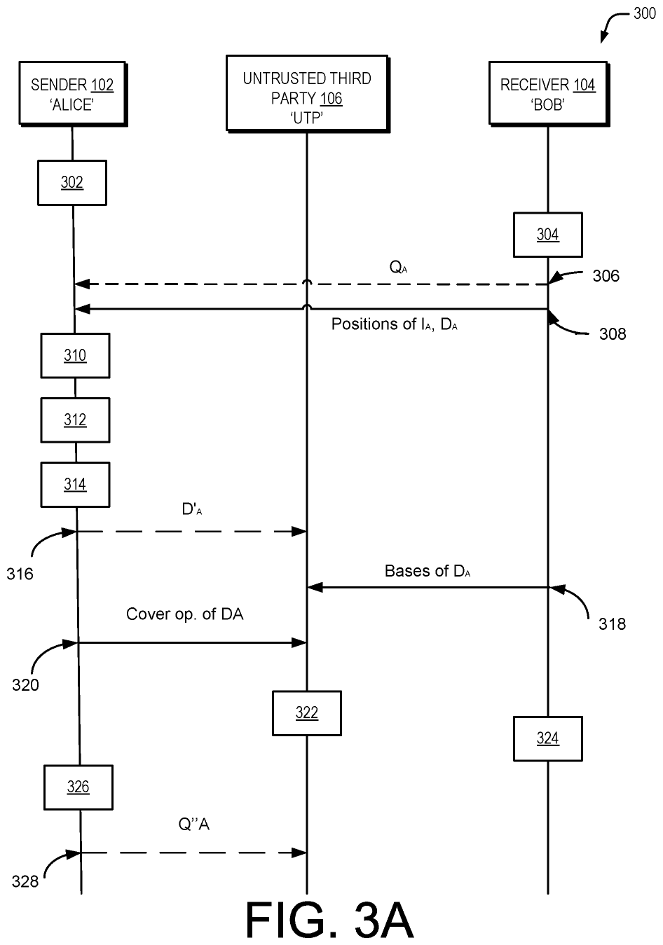

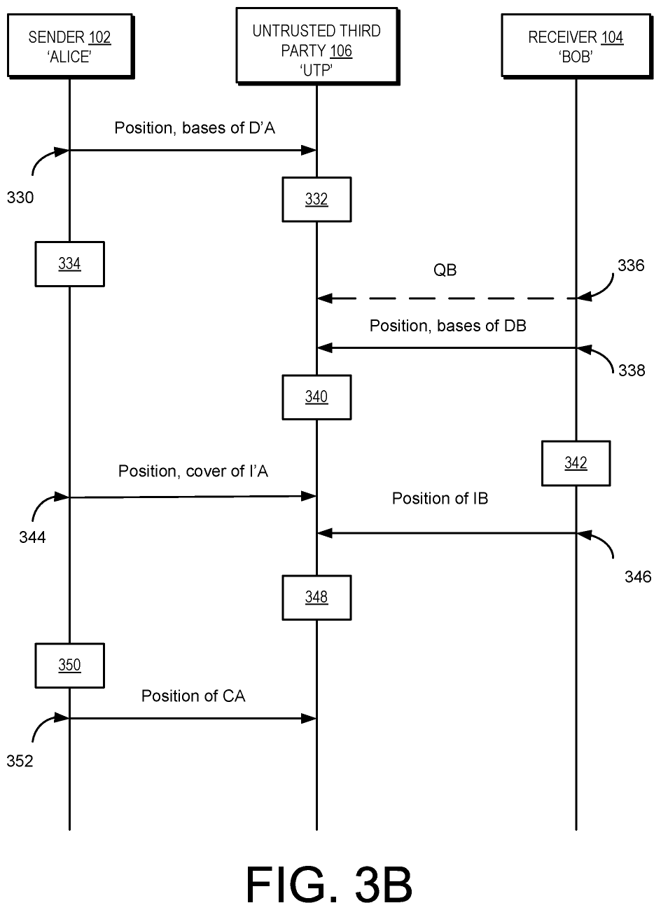

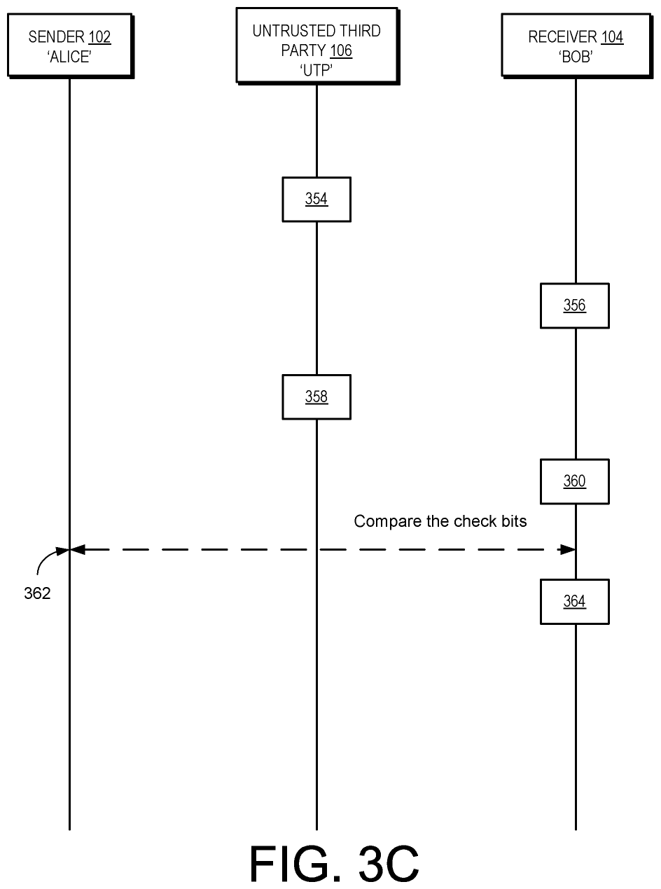

The functioning of the system 200 and the UTP 218 are now described with respect to different processes undertaken by any one or more of the engines 206 and the measuring device 224 in conjunction with a process flow diagram as depicted in FIG. 3. FIG. 3 depicts a process flow diagram illustrating a functional and sequential flow of steps 300 for implementing measurement device independent quantum secure direct communication with user authentication, as per one example. In an example, the encoding engine 208 of the sender 102 may initially encode the message, such as the message M to be shared by sender 102 with receiver 104. As depicted by block 302 of FIG. 3, the encoding process may begin with the encoding engine 208 introducing one or more random check bits c, in random positions of the n-bit message M which is to be sent to receiver 104. The updated message stream may be denoted as M′, which includes n′=n+c bits, where c is the number of check bits that have been introduced by the encoding engine 208. In an example, it may be assumed that the length of M′ may be even, i.e., n+c=2N, where N may be any integer.

In another example, the security engine 210 of receiver 104 may prepare first set of entangled qubit bit pairs, i.e., first set of (N+k) EPR pairs. In one example, the security engine 210 may prepare the EPR pair randomly in |Φ⁺ [symbol] , |Φ⁻ [symbol] , |Ψ⁺ [symbol] and |Ψ⁻ [symbol] states (i.e., in entangled state). As may be understood, the term ‘state’ may denote one of a variety of degree of freedom such as electron spin, polarization, angular momentum, etc., among other possible degrees of freedom. Once the EPR pairs are prepared, the receiver 104 may separate the entangled qubit pairs into the first particle sequences and second particle sender 102 S_{A} and S_{B}, respectively, each of length N+k where S_{A} is formed by taking out one qubit from each pair, and the remaining partner qubits are to form S_{B}.

Once the particle sequences S_{A} and S_{B} are prepared, in an example, the security engine 210 of receiver 104 may also prepare a second set of k EPR pairs in accordance with the identity of receiver 104, i.e., Id_{B}. In one example, for 1≤i≤k, i being the i-th qubit pair, Iᵢ, may be prepared as one of |Φ⁺ [symbol] , |Φ³¹ [symbol] , |Ψ⁺ [symbol] and |Ψ⁻ [symbol] , if the value of Id_{B,(2i-1)} Id_{B,2i} is one of 00, 01, 10 and 11, respectively. With the EPR pairs prepared in accordance with the identity of the receiver 104, the security engine 210 may further create first and second sequences of single photons depicted by I_{A} and I_{B} wherein which the i-th qubits of the sequences I_{A} and I_{B} are partners of each other in the i-th EPR pair Iᵢ.

Thereafter, the security engine 210 of receiver 104 may then also prepare two sequences of decoy photons to be inserted into random positions within a qubit stream. In an example, the first and second sequences of decoy photons may be represented as D_{A} and D_{B}. In another example, the decoy photons may be prepared in Z-basis or X-basis among other possible scenarios. In one example, Z-basis and X-basis may be represented as:

$$Z basis = \{ \vert 0 〉 , \vert 1 〉 \} basis . \\ \vert + 〉 = \frac{1}{\sqrt{2}} ( \vert 0 〉 + \vert 1 〉 ) , \vert - 〉 = \frac{1}{\sqrt{2}} ( \vert 0 〉 - \vert 1 〉 ) . \\ X basis = \{ \vert + 〉 , \vert - 〉 \} basis .$$

Thereafter, the encoding engine 208 of the receiver 104 may interleave the previously prepared corresponding sequences while maintaining the relative ordering of each set to generate two new sequences. In an example, the qubits of I_{A}, D_{A}, and S_{A} may be interleaved to generate a first sequence of single qubit bits Q_{A} such that Q_{A}=S_{A}∪I_{A}∪D_{A}. In another example, the qubits of I_{B}, D_{B}, and S_{B} may be interleaved to generate the second sequence of the single qubit bits Q_{B}, such that Q_{B}=S_{B}∪I_{B}∪D_{B}.

As depicted at step 306, receiver 104 may retain the Q_{B} sequence and may send the Q_{A} sequence to sender 102 through a quantum channel, such as the quantum channel 108. In an example, upon the sender 102 receiving the Q_{A} sequence, at step 308 the receiver 104 may share the positions of the qubits of I_{A} and D_{A}. In an example, encoding engine 208 of the receiver 104 may send the Q_{A} sequence to sender 102 over the quantum channel 108. In another example, once sender 102 receives the Q_{A} sequence, the encoding engine 208 of the receiver 104 may announce the positions of the qubits of I_{A} to sender 102. In one example, this announcement may be done publicly.

As depicted in block 310, once sender 102 receives the Q_{A} sequence and the details of the qubit positions of I_{A} and D_{A} are announced by the receiver 104, the decoding engine 214 of sender 102 may separate the qubits of S_{A}, I_{A} and D_{A} from Q_{A}. Then, in an example, the encoding engine 208 of sender 102 may randomly select N qubits from the S_{A} to encode the secret message M′. In another example, the remaining K qubits (denoted hereafter as C_{A}) may be used to encode the secret identity of sender 102, i.e., Id_{A}. As may be noted, here the encoded process for M′ and Id_{A} may be the same. In one example, the encoding engine 208 may encode two bits (such as, 00, 01, 10, 11) of classical information into one qubit by applying any unitary operator. In a particular example, encoding engine 208 uses Pauli operators (which are known to be unitary operators) I, σₓ, iσ_{y} and σ_{z} to encode the classical information into qubits. Here, it is pertinent to note other unitary operators may also be used by the encoding engine 208 as well. As may be understood, after applying a unitary operator to S_{A} (with classical information), the modified first particle sequence S′_{A} (with qubits) is thus obtained.

Thereafter, the encoding engine 208 of sender 102 may apply unitary operators on the qubits I_{A} to form a new modified first single photon sequence I′_{A}. Once I′_{A} is obtained, the encoding engine 208 may randomly inserts qubits of I′_{A} into in random positions of S′_{A} to provide a modified first sequence Q′_{A} (at block 312). In an example, the sequence Q′_{A} may be represented as Q′_{A}=I′_{A}∪S′_{A}.

The method 300 may continue further wherein which at block 314, the sender 102 may apply cover operators on the qubits of D_{A} to produce a new modified first set of decoy photons D′_{A}. In an example, the cover operations may be applied from a set of operators from {I, iσ_{y}, H, iσ_{y}H} which are applied onto the qubits of D_{A}. At step 316 the sender 102 may sends D′_{A} to the UTP 106 to check the channel security from receiver 104 to sender 102.

The method 300 may now continue with respect to certain steps being performed by the UTP 106. At block 318, the UTP 106 receives the sequence D′_{A} with the receiver 104 announcing the preparation bases of the qubits of D_{A}. Correspondingly, at step 320, the sender 102 announces the corresponding cover operations used by it to transform D_{A} into D′_{A}. In an example, the encoding engine 208 of receiver 104 may announce information about the preparation basis of the qubits of D_{A} (prepared by receiver 104 at block 304). In another example, the encoding engine 208 of sender 102 may announce the information about the corresponding cover operations applied to D_{A} by sender 102 (at block 314).

At block 322, UTP 106 measures the qubits of D′_{A} in proper basis and announces the result. In an example, the measuring device 224 of UTP 218 may measure the qubits of D′_{A} in proper basis and announces the result. In one example, if the cover operations performed by sender 102 belong to any one of the operators in the set {I, iσ_{y}, H, iσ_{y}H}, then the measuring device 224 may change the basis to measure the corresponding qubit. For example, if the i-th qubit of D_{A} be prepared in Z-basis and the i-th cover operation be iσ_{y}H, then measuring device 224 may measure the i-th qubit of D′_{A} in X-basis. At block 324, based on the measurement results obtained by the measurement device 224, the sender 102 and receiver 104 may calculate the error in the communication channel from receiver 104 to sender 102. If the value of the error is greater than a predefined threshold, the receiver 104 may terminate the communication. On the other hand, if the value of the error thus determined is less than the predefined threshold the communication may further continue with the method 300 continuing to block 326. In an example, the error calculations may be performed by decoding engines 214 of the corresponding sender 102, and the receiver 104. In another example, the authentication engine 212 may compare the determined error with the predetermined threshold to ascertain the safety of the quantum channel 108. If the channel is deemed to be unsafe, the authentication engine 212 may abort their respective communication over the quantum channel 108.

Returning to the process, at block 326, the sender 102 may insert a new set of d′ decoy photons D′_{A} into random positions of Q′_{A}, resulting in a new sequence Q″_{A}. The process further continues with the sender 102, at step 328, sending Q″_{A}-sequence to the UTP 106. In one example, the encoding engine 208 of sender 102 may generate a new of decoy photons d′ (referred hereafter as D′_{A}) and may insert them randomly in Q′A to generate a further modified sequence Q″_{A}. In another example, the encoding engine 208 may send the further modified sequence Q″_{A} to the UTP 106.

At step 330, the sender 102 may announce the positions and the preparation bases of the decoy qubits of D′_{A}. The process may further continue with the UTP 106, at block 332, measuring the decoy qubits and publishing the measurement results. From amongst the measurement results, the sender 102 at block 334 calculates the error in the quantum channel (i.e., the channel 108) between sender 102 and UTP 106 to check the security of the quantum channel from sender 102 to UTP 106. If the estimated error is greater than some threshold value, then they terminate the communication and otherwise go to the next step. In an example the encoding engine of sender 102 may announce the positions and the preparation bases of the decoy qubits of D′_{A}. In another example, the measuring device 224 of UTP 218 may measure the decoy qubits and may publish the measurement results. Similar to block 324, at block 334, sender 102 may check the security of the quantum channel 108 from sender 102 to UTP 106 and decide whether to abort the communication.

At step 336, receiver 104 sends the sequence Q_{B} to UTP 106. When all the qubits of Q_{B} have reached the UTP 106, at step 338, receiver 104 announces the positions and the preparation bases of the decoy qubits of D_{B}. At block 340, the UTP 106 measures such qubits in proper bases and discloses the measurement results. At this stage, the receiver 104 (as depicted at block 342) may calculate the error in the quantum channel between receiver 104 and UTP 106. Similar to block 334, at block 342 receiver 104 may check the security of the quantum channel 110 from receiver 104 to UTP 106 and decide whether to abort the communication.

If the process is to continue (i.e., it was determined that the communication is to be continue), both the sender 102 and the receiver 104 may perform authentication of each other. At block 344, the sender 102 announces the positions and the cover operations of the qubits of I′_{A}. Once the positions and the cover operations are announced, at step 346, the receiver 104 announces the positions of the qubits of I_{B}. The process continues wherein which at block 348, for ≤i≤k, the UTP 106 measures the i-th qubit pair (I′_{A,i}, I_{b,i}). In an example, the UTP 106 may measure the i-th qubit pair (I′_{A,i}, I_{b,i}) in Bell basis. Thereafter, the uTP 106 may announces the result. At block 350, since sender 102 already knows the identity of receiver 104, i.e., Id_{B}, it also knows the exact state of each Iᵢ, which is the joint state I_{A,i,} I_{B,i}. In an example, the decoding engine 214 of the sender 102 may randomly apply unitary operators (such as Pauli operators) on I_{A,i}, the joint state changes to I′_{A,i}, I_{B,i}. In an example the authentication engine 216 may compare the measurement result by the UTP 106 with I′_{A,i},I_{B,i} to confirm the identity of receiver 104.

At step 352, sender 102 announces the positions of the qubits of C_{A} corresponding to the sender 102 identity Id_{A}. At block 354, in response to the announcement of the positions of the qubits of C_{A}, the UTP 106 may measure these qubits with their partner qubits from S_{B} (referred, hereafter as C_{B}) in Bell bases and announces the measurement result. Similar to the processing at block 350, the receiver 104 may confirm the identity of sender 102 in a similar manner, at block 356.

At block 358, the UTP 106 measures each qubit pair from (S′_{A}, S_{B}) in Bell basis and announces the measurement result. As may be understood, from the knowledge of (S_{A}, S_{B}) and (S′_{A}, S_{B}), the decoding engine 214 of receiver 104 may decode the classical bit string M′ at block 360. Finally, at step 362, sender 102 and receiver 104 may publicly compare the random check bits ‘c’ to check the integrity of the messages. As may be understood, since receiver 104 decoded the message M′ in the previous step, the decoding engine 214 of the receiver 104, in an example, may decode the secret message M (since it has already been established that M′=n+c), at block 364.

In one example, the proposed MDI-QSDC protocol may be generalized into an MDI-Quantum Dialogue (MDI-QD) protocol that also provides mutual user authentication. In this particular example, both sender 102 (herein, denoted as Alice) and receiver 104 (herein, denoted as Bob) may send their secret message to each other simultaneously after confirming the authenticity of the other user. They may use one EPR pair to exchange one-bit message from each other. In this example, receiver 104 may randomly prepare EPR pair |Φ⁺ [symbol] or |Ψ⁺ [symbol] (|Φ⁻ [symbol] or |Ψ⁻ [symbol] ) corresponding to its secret message bit 0 or 1. Then, sender 102 may randomly apply Pauli operator I or σ_{z} (σₓ or iσ_{y}) to encode her message bit 0 or 1 (See Table 1). The rest of the procedure is the same as the above MDI-QSDC protocol described in the present disclosure. As may be understood, the security of the MDI-QD protocol directly follows from the MDI-QSDC protocol.

TABLE 1
Encoding rules for MDI-QD protocol

| Message bit | | Bob prepares | Alice's unitary | Final joint state |
|---|---|---|---|---|
| Alice | Bob | (S_{A}, S_{B}) | S_{A} to S′_{A} | (S′_{A}, S_{B}) |
| 0 | 0 | \|Φ⁺ [symbol] | I | \|Φ⁺ [symbol] |
| | | | σ_{z} | \|Φ⁻ [symbol] |
| | | \|Ψ⁺ [symbol] | I | \|Ψ⁺ [symbol] |
| | | | σ_{z} | \|Ψ⁻ [symbol] |
| 0 | 1 | \|Φ⁻ [symbol] | I | \|Φ⁻ [symbol] |
| | | | σ_{z} | \|Φ⁺ [symbol] |
| | | \|Ψ⁻ [symbol] | I | \|Ψ⁻ [symbol] |
| | | | σ_{z} | \|Ψ⁺ [symbol] |
| 1 | 0 | \|Φ⁺ [symbol] | σₓ | \|Ψ⁺ [symbol] |
| | | | iσ_{y} | \|Ψ⁻ [symbol] |
| | | \|Ψ⁺ [symbol] | σₓ | \|Φ⁺ [symbol] |
| | | | iσ_{y} | \|Φ⁻ [symbol] |
| 1 | 1 | \|Φ⁻ [symbol] | σₓ | \|Ψ⁻ [symbol] |
| | | | iσ_{y} | \|Ψ⁺ [symbol] |
| | | \|Ψ⁻ [symbol] | σₓ | \|Φ⁻ [symbol] |
| | | | iσ_{y} | \|Φ⁺ [symbol] |

The above-mentioned approaches, as also discussed briefly above, provide a number of distinct technical advantages. For example, the present approaches have been determined to be very resilient and efficient in averting different types of attacks such an impersonation attack, side-channel attacks, intercept-and-resend attack, entangle-and-measure attack, DoS attack, man-in-the-middle attack, information leakage attack, and trojan horse attack. Furthermore, the present subject matter also with minimum overhead in a noisy scenario as long as the duration of the ideal channel is below a certain threshold.

Although examples for the present disclosure have been described in language specific to structural features and/or methods, it is to be understood that these example are not necessarily limited to the specific features or methods described. Rather, the specific features and methods are disclosed and explained as examples of the present description.

1. A quantum communication system, comprising:
a quantum processing unit;
an engine coupled to the quantum processing unit, wherein the encoding engine is to:
prepare a first set of entangled qubit bit pairs, wherein the qubit bit pairs are prepared randomly using Bell bases;
separate the first set of entangled qubit bit pairs into a first particle sequence and a second particle sequence;
prepare a second set of entangled qubit bit pairs based on an identifier corresponding to the quantum communication system;
generate:
a first single photon sequence corresponding to a sending system from which a message is to be received; and
a second single photon sequence corresponding to the quantum communication system;
interleave a first set of decoy photons into the first particle sequence and the first single photon sequence, and a second set of decoy photons into the second particle sequence and the second single photon sequence to provide a first sequence and a second sequence of single qubits corresponding to the sending system and the quantum communication system, respectively;
communicate the second sequence to an untrusted third party; and
continue communication with the sending system based on a measurement result determined based on the second sequence.

2. The system as claimed in claim 1, wherein the entangled qubit bit pairs are Einstein-Podolsky-Rosen (EPR) pairs.

3. The system as claimed in claim 1, wherein:
the first particle sequence is formed by taking out one qubit from each of the first set of entangled qubit bit pairs; and
the second particle sequence is formed by each of the one qubit taken out from each of the first set of entangled qubit pairs.

4. The system as claimed in claim 2, wherein the first single photon sequence and the second single photon sequence are partner sequences of each other in the i-th EPR pair.

5. The system as claimed in claim 1, wherein each of the first set of decoy photons and the second set of decoy photons are prepared based on one of a X-bases and a Z-bases, wherein:
$$Z basis = \{ \vert 0 〉 , \vert 1 〉 \} basis \\ basis = \{ \vert + 〉 , \vert - 〉 \} basis \\ further wherein \vert + 〉 = \frac{1}{\sqrt{2}} ( \vert 0 〉 + \vert 1 〉 ) , \vert - 〉 = \frac{1}{\sqrt{2}} ( \vert 0 〉 - \vert 1 〉 ) .$$

6. The system as claimed in claim 1, wherein on obtaining the first sequence and the second sequence, the engine is to further:
communicate the first sequence to the sending system, while retaining the second sequence through a quantum communication channel between the quantum communication system and the sending system; and
communicate positions of qubits corresponding to the first single photon sequence and the second decoy photons.

7. The system as claimed in claim 1, wherein on communicating all bits of the second sequence to the untrusted third party, the engine is to announce positions and preparation bases of the qubits of the second set of decoy photons.

8. The system as claimed in claim 1, wherein to continue communication, the engine is to:
compare the measurement result with a predefined threshold value;
on determining the measurement result to be greater than the predefined values, discontinuing communication with the untrusted third party; and
on determining the measurement result to be less than the predefined values, continuing communication with the untrusted third party.

9. A method comprising:
receiving by a sending system a first sequence of single qubits from a receiving system, through a quantum communication channel, wherein the first sequence is generated by interleaving a first set of decoy photons into a first particle sequence and a first single photon sequence, wherein each of the first sequence, first set of decoy photons and the first single photon sequence correspond to the sending system intending to a transmit a message to the receiving system;
separating qubits corresponding to the first particle sequence, the first single photon sequence and the first set of decoy photons;
selecting from the first particle sequence, a random number of qubits to encode a message to be transmitted to the receiving system;
encoding an identifier corresponding to the sending system based on another number of qubits;
applying a unitary operator on the qubits corresponding to the first single photon sequence to provide a modified first single photon sequence;
inserting qubits of the modified first single photon sequence into random positions of a modified first particle sequence to obtain a modified first sequence of single qubits; and
obtaining and communicating a modified first set of decoy photons to an untrusted third party to ascertain security of the quantum communication channel between the sending system and the receiving system.

10. The method as claimed in claim 9, wherein the modified first particle sequence is obtained by encoding a predefined number of bits of classical information into each qubit corresponding to the first particle sequence.

11. The method as claimed in claim 10, wherein the bits of classical information is applied using a Pauli operator, the Pauli operator being from a group comprising of the I, σₓ, iσ_{y} and σ_{z} operators.

12. The method as claimed in claim 9, wherein the modified first set of the decoy photons is obtained by applying a cover operation over the qubits of the first set of decoy photons, wherein the cover operation is by way of an operator selected from a group comprising {I, iσ_{y}, H, iσ_{y}H} operators.

13. The method as claimed in claim 12, wherein on communicating the modified first set of decoy photons to the untrusted third party, the sending system is to announce the cover operations applied over the qubits of the first set of the decoy photons.

14. The method as claimed in claim 9, wherein the sending system is to further modify the modified first sequence of single qubits, by inserting the modified qubits corresponding to the first set of decoy photons into random positions of the modified first sequence of single qubits to provide a further modified first sequence.

15. The method as claimed in claim 14, wherein the sending system is to send the further modified first sequence to the untrusted third party.

16. The method claimed in claim 9, wherein the method comprises:
announcing, by the sending system, positions and preparation bases of the modified first single photon sequence;
receiving measurement results obtained from the untrusted third party, wherein the measurement results are obtained based on the modified first single photon sequence;
calculating an error in the quantum communication channel between the sending system and the untrusted third party; and
terminating the communication between the sending system and the untrusted third party if the calculated error is greater than a predefined threshold.

17. The method as claimed in claim 9, wherein the sending system is to perform authentication by:
announcing positions and cover operations of the qubits of the modified first single photon sequence;
receiving, from the receiving system, announce positions of qubits of a second single photon sequence, wherein the second single photon sequence corresponds to the receiving system;
authenticating the identity of the receiving system based on the modified first single photon sequence and the second single photon sequence.

18. A non-transitory computer-readable medium comprising computer-readable instructions being executable by a quantum processing resource to:
receive a modified first single set of decoy photons from a sending system;
measure the qubits of the modified first single set of decoy photons as per appropriate bases to obtain the measurement result, wherein the qubits of the modified first single set of decoy photons are measured based on one of the X-basis or Z-basis; and
communicate the measurement result to the sending system and the receiving system.

19. The non-transitory computer-readable medium as claimed in claim 18, wherein the instruction are executable to receive a further modified first sequence of single qubits.

20. The non-transitory computer-readable medium as claimed in claim 18, wherein the instruction are executable to:
receive positions and preparation bases of the qubits of the modified first set of decoy photons from the sending system;
receive positions and preparation bases of the qubits of the second set of the decoy photons from the receiving system;
determine measurement results for the sending system and the receiving system, wherein the sending system and receiving system are to further calculate an error in quantum communication channel based on the measurement results.
